(19) United States
(12) Patent Application Publication
(10) Pub. No.: US 2005/0257885 A1
(43) Pub. Date: Nov. 24, 2005

(54) Capillary multi-channel optical flow cell

(75) Inventor: Steven E. Hobbs, West Hills, CA (US)

Correspondence Address: Intellectual Property / Technology Law;Attention: Vincent K. Gustafson, PO Box 14329, Research Triangle Park, NC, 27709, US

(73) Assignee: Nanostream, Inc., Pasadena, CA (US)

(21) Appl. No.: 11/102,907

(22) Filed: Apr. 8, 2005

Related U.S. Application Data
(60) Provisional application No. 60/574,240, filed on May 24, 2004.

(51) Int. Cl. B01D 15/08

(52) U.S. Cl. 156/293; 210/198.2

(57) ABSTRACT

A first multi-channel optical flow cell includes a two end blocks disposed around a channel-defining flow layer, with a first end block having multiple inlet ports each containing an associated optical fiber and fluid conduit terminated substantially flush against an inner surface of the first end block. The second end block may have multiple outlet ports each containing at least one of an additional optical fiber and additional fluid conduit. A method for fabricating a multi-channel flow cell includes inserting a first plurality of optical fibers and a first plurality of fluid conduits through a plurality of inlet ports defined in a first end block, sealing the optical fibers and conduits, polishing the optical fibers, and then positioning and joining a channel-defining flow layer between the first end block and a second end block.

### STATEMENT OF RELATED APPLICATION(S)

This application claims benefit of commonly assigned U.S. provisional patent application No. 60/574,240 filed on May 24, 2004.

### FIELD OF THE INVENTION

The present invention relates to analytical systems including a multiple channel optical flow cell for analyzing multiple flowing samples.

### BACKGROUND OF THE INVENTION

Recent developments in the pharmaceutical industry and in combinatorial chemistry have exponentially increased the number of potentially useful compounds, each of which must be characterized in order to identify their active components and/or establish processes for their synthesis. To more quickly analyze these compounds, researchers have sought to automate analytical processes and to implement analytical processes in parallel. Commonly employed analytical processes include chemical or biochemical separations such as chromatographic, electrophoretic, electrochromatographic, immunoaffinity, gel filtration, and density gradient separations.

One particularly useful analytical process is chromatography, which encompasses a number of methods that are used for separating ions or molecules that are dissolved in or otherwise mixed into a solvent. Liquid chromatography (“LC”) is a physical method of separation wherein a liquid “mobile phase” (typically consisting of one or more solvents) carries a sample containing multiple constituents or species through a separation medium or “stationary phase.” Stationary phase material typically includes a liquid-permeable medium such as packed granules (particulate material) or a microporous matrix (e.g., porous monolith) disposed within a tube or similar boundary. The resulting structure including the packed material or matrix contained within the tube is commonly referred to as a “separation column.” In the interest of obtaining greater separation efficiency, so-called “high performance liquid chromatography” (“HPLC”) methods utilizing high operating pressures are commonly used.

In operation of a separation column, sample constituents borne by mobile phase migrate according to interactions with the stationary phase, and the flow of these sample constituents are retarded to varying degrees. Individual constituents may reside for some time in the stationary phase (where their velocity is essentially zero) until conditions (e.g., a change in solvent concentration) permit a constituent to emerge from the column with the mobile phase. The time a particular constituent spends in the stationary phase relative to the fraction of time it spends in the mobile phase will determine its velocity through the column.

Following separation in an LC column, the eluate stream contains series of regions having an elevated concentration of individual sample constituents or species, which can be detected by various flow-through techniques. Examples of such techniques include fluorescence analysis, absorption analysis, Raman spectroscopy, and other optical detection techniques (hereinafter referred to collectively as “optical detection”).

Fluorescence analysis (including any of spectrometry and spectroscopy) involves the excitation of a particular molecular or atomic species to an (e.g., electronically) excited state by absorption of radiation. The subsequent radiative relaxation, or fluorescence, of the excited species back to the ground state is then monitored by an appropriate detector. Due to energy dissipation during the excited-state lifetime, the emitted photons are of lower energy, and therefore of longer wavelength, than the excitation photons. This difference in energy, called the Stokes shift, is fundamental to the sensitivity of fluorescence techniques because it allows emission photons to be detected against a low background, isolated from excitation photos. Major benefits afforded by fluorescence detection include inherently high sensitivity coupled with a high degree of specificity. Specific excitation and emission wavelength profiles aid in the characterization of individual components of a sample.

Absorption analysis (including any of spectrometry and spectroscopy) involves the illumination of a particular molecule with a specific wavelength or range of wavelengths of electromagnetic radiation—commonly in the ultraviolet or visible range. The samples absorb the radiation in directly proportional to the path length of the radiation through the sample and the concentration of the absorbing species in the sample. Because different molecules absorb radiation of different wavelengths, the absorption spectrum will show a number of absorption bands corresponding to structural groups within the molecule.

Early parallel LC systems coupled multiple conventional tubular columns to common fluid supply and/or control systems, and provided only marginal benefits in terms of scalability and reduced cost per separation. Recent advances in microfluidic technology have allowed fabrication of microfluidic multi-column HPLC devices that permit simultaneous (parallel) separation of multiple samples while using very small quantities of valuable samples and solvents. Examples of such devices are disclosed in commonly assigned U.S. Patent Application Publication No. 2003/0150806 entitled “Separation Column Devices and Fabrication Methods,” which is hereby incorporated by reference. These microfluidic devices require far fewer parts per column than conventional HPLC columns, and may be rapidly connected to an associated HPLC system without the use of threaded fittings, such as by using flat compression-type interfaces either with or without associated gaskets. A further benefit of microfluidic parallel HPLC devices is that their relatively low cost and ease of connection permits them to be disposed of after a single or only a small number of uses, thus eliminating or substantially reducing the potential for sample carryover from one separation run to the next.

Conventional optical detection flow cells for use with HPLC devices are typically designed for use with a single channel or column. For example, U.S. Pat. No. 5,073,345 to Scott, et al. (“Scott”) and U.S. Pat. No. 6,542,231 to Garrett (“Garrett”) disclose single channel optical flow cells intended for use with absorption spectrometry. These flow cells are mechanically complex, thus increasing the complexity of manufacturing, operating and maintaining systems employing such flow cells. In a single channel system, these added complexities may not interfere with the operation of the system; however, the complexity of such devices could impose significant operational limitations on systems having a large number of channels.

For example, Scott uses optical elements between the detection region of the flow cell and the illumination source and detectors. As a result, the signal through the flow cell may experience Fresnel reflection loss. Fresnel reflection loss, or “Fresnel loss,” is the signal loss that takes place at any discontinuity of refractive index, especially at an air-glass interface, at which a fraction of the optical signal is reflected back toward the source. Fresnel loss can be significant, substantially affecting the sensitivity and resolution of absorption or fluorescence measurements.

Garrett minimizes Fresnel losses by using two optical fibers inserted directly into the detection region of the flow cell where they are directly coupled with the fluid therein. A first fiber is used to deliver the illumination signal to the detection region and the second fiber is positioned opposite the first fiber to collect the illumination signal once it has passed through the fluid in the detection region. However, if multiple such flow cells are used in conjunction with a parallel LC system, the alignment of the optical fibers is critical to obtaining repeatable results from one flow cell to another. In other words, the distance between the ends of the optical fibers in the flow cell defines the length of the detection region. Even very small variations in this distance from one flow cell to another can result in significantly differing results from flow cell to another. Thus, fabrication of such flow cells requires very precise, complex, and time consuming assembly operations or equally precise, complex and time consuming calibration operations prior to use of a system incorporating multiple such flow cells.

U.S. Pat. No. 6,452,673 to Leveille, et al. illustrates a flow cell for use with absorption spectrometers that permits multiple inputs to be channeled through a single flow cell. While such a flow cell may be suitable for performing detections of multiple analyte streams provided in series, the device would not be suitable for performing detections of multiple analyte streams in parallel.

Moreover, none of the above-referenced devices would be suitable for performing fluorescence analysis because fluorescence measurements must be obtained by sensing the excitation radiation that emanates at some angle from the axis of the excitation light. This is because the excitation radiation signal is typically much more powerful than the fluorescence signal; thus, by placing a detector at some angle from the axis of the excitation signal, the strength of the excitation signal incident on the detector is reduced. Consequently, the strength of the fluorescence signal, which emanates omni-directionally from the sample and thus remains constant, is more easily detected. All of the above-referenced devices are fabricated from opaque or translucent materials and structured in a manner that would interfere with or block any off-axis signals emanating from samples contained therein. As a result, if fluorescence detection capability were desired, then additional flow cells suitable for fluorescence analysis would be required. Providing multiple flow cells of differing designs would increase the complexity of such an instrument.

In single-column LC systems, it is relatively simple to provide a substantially transmissive or transparent flow-through detection region and align an excitation source, a detector, and appropriate optical components relative to the detection region so as to obtain useful and repeatable analytical results. Extending optical detection to multi-column (e.g., parallel) LC systems, however, is significantly more challenging.

Ideally, to promote both efficiency of both cost and physical packaging, optical detection with a multi-column LC system would be performed with common components such as one or more common excitation source(s) and a common (multi-channel) detector. Cross-talk between adjacent detector channels should be minimized, yet an ideal detection system would also provide similar optical geometries (e.g., optical path lengths and incidence angles) for each channel to minimize variations in response. The reduced footprint of microfluidic LC devices better facilitates the use of common detection components and similar optical geometries than larger (e.g., conventional scale) multi-column systems. If it is desired to utilize flat compression-type (i.e., threadless) interfaces with microfluidic parallel LC devices, however, the presence of moveable interface components would complicate the packaging and use of optical detection methods with on-device detection regions. If external flow-through detection regions downstream of a microfluidic LC device are used, then it would be desirable to minimize the number of fluidic connections to these external components so as to reduce the potential for detrimental band broadening within the eluate streams.

In light of the foregoing, there exists a need for improved optical detection components and systems capable of interfacing with multi-channel LC systems. Desirable characteristics of an integrated system would include one or more of the following: low overall cost, ease of manufacture and maintenance, small physical size/volume, minimal variation in response between channels, minimal number of fluidic connections, minimal number of optical interfaces, and scalability. In addition, it would be desirable to provide a single flow cell design capable of allowing a variety of measurements to be taken, including, but not limited to, fluorescence and absorption measurements.

### BRIEF DESCRIPTION OF THE DRAWINGS

FIG. 1A is a simplified front cross-sectional view of a first multi-channel optical detection flow cell.

FIG. 1B is a simplified side cross-sectional view of the multi-channel optical detection flow cell of FIG. 1A.

FIG. 1C is an enlarged side cross-sectional view of a portion of the multi-channel optical detection flow cell of FIGS. 1A-1B.

FIG. 1D is a cross-sectional schematic view of a portion of the multi-channel optical detection flow cell of FIG. 1A and the associated optical components for performing fluorescence analysis.

FIG. 2 is a front cross-sectional view of a portion of a second multi-channel optical detection flow cell.

FIG. 3A is a perspective view of a third multi-channel optical detection flow cell.

FIG. 3B is a front view of the multi-channel optical detection flow cell of FIG. 3A.

FIG. 3C is an exploded perspective view of the multi-channel optical detection flow cell of FIGS. 3A-3B.

FIG. 4A is a perspective view of the flow layer of the multi-channel optical detection flow cell of FIGS. 3A-3C.

FIG. 4B is a front view of the flow layer of the multi-channel optical detection flow cell of FIGS. 3A-3C.

FIG. 5A is a front view of a first alternative flow layer suitable for use with a multi-channel optical detection flow cell similar to the device of FIGS. 3A-3C.

FIG. 5B is a front view of a second alternative flow layer suitable for use with a multi-channel optical detection flow cell similar to the device of FIGS. 3A-3C.

FIG. 6A is a front view of a portion of a third alternative flow layer suitable for use with a multi-channel optical detection flow cell similar to the device of FIGS. 3A-3C.

FIG. 6B is a side cross-sectional view of a portion of a fourth alternative flow layer suitable for use with a multi-channel optical detection flow cell similar to the device of FIGS. 3A-3C.

FIG. 6C is a side cross-sectional view of a portion of a fifth alternative flow layer suitable for use with a multi-channel optical detection flow cell similar to the device of FIGS. 3A-3C.

FIG. 6D is a front view of a portion of a sixth alternative flow layer suitable for use with a multi-channel optical detection flow cell similar to the device of FIGS. 3A-3C.

FIG. 6E is a front view of a portion of a seventh alternative flow layer suitable for use with a multi-channel optical detection flow cell similar to the device of FIGS. 3A-3C.

FIG. 6F is a front view of portion of an eighth alternative flow layer suitable for use with a multi-channel optical detection flow cell similar to the device of FIGS. 3A-3C.

FIG. 6G is a front cross-sectional view of a portion of ninth alternative flow layer suitable for use with a multi-channel optical detection flow cell similar to the device of FIGS. 3A-3C.

FIG. 6H is a front view of an optical mask disposed over the portion of the flow layer of FIG. 6G.

FIG. 7A is a front cross-sectional schematic view of a portion of a fourth multi-channel optical detection flow cell with fluidic conduits interfaced to a first outer layer, optical conduits interfaced to a flow layer, and an associated detector.

FIG. 7B is a front cross-sectional schematic view of a portion of a fifth multi-channel optical detection flow cell with fluidic conduits interfaced to a first outer layer, optical conduits interfaced to optical conduit termination blocks adjacent to the flow layer, and an associated detector.

FIG. 8 is a system schematic showing interconnections of various components of a high throughput analytical system including multiple separation columns and a multi-capillary flow cell in optical communication with a multi-channel optical detector.

### DETAILED DESCRIPTION OF PREFERRED EMBODIMENTS OF THE INVENTION

The present invention provides multi-channel optical flow cells suitable for use with parallel chromatography systems. Flow cells according to the invention are easily fabricated and provide compact, serviceable units. Flow cells according to the invention also provide low dead volume, thus minimizing the potential for brand broadening. Additionally, such flow cells minimize the use light-attenuating air/glass interfaces, further enhancing performance. Furthermore, flow cells according to the present invention may be used for performing both fluorescence and absorption analysis.

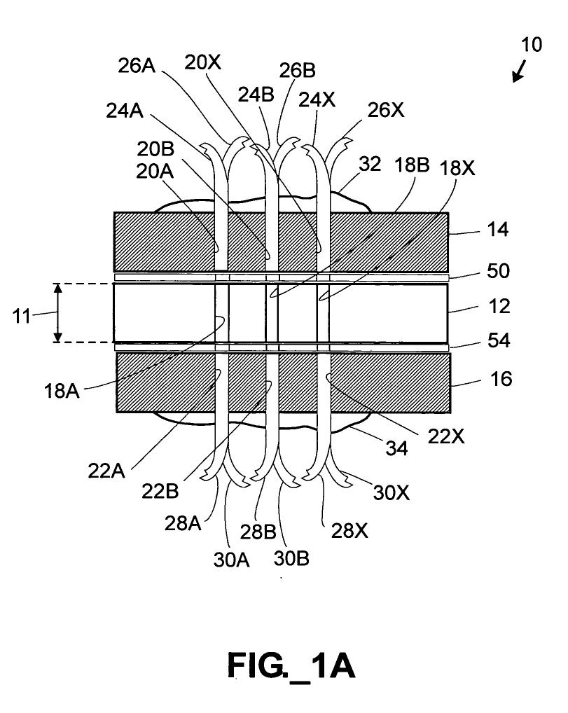

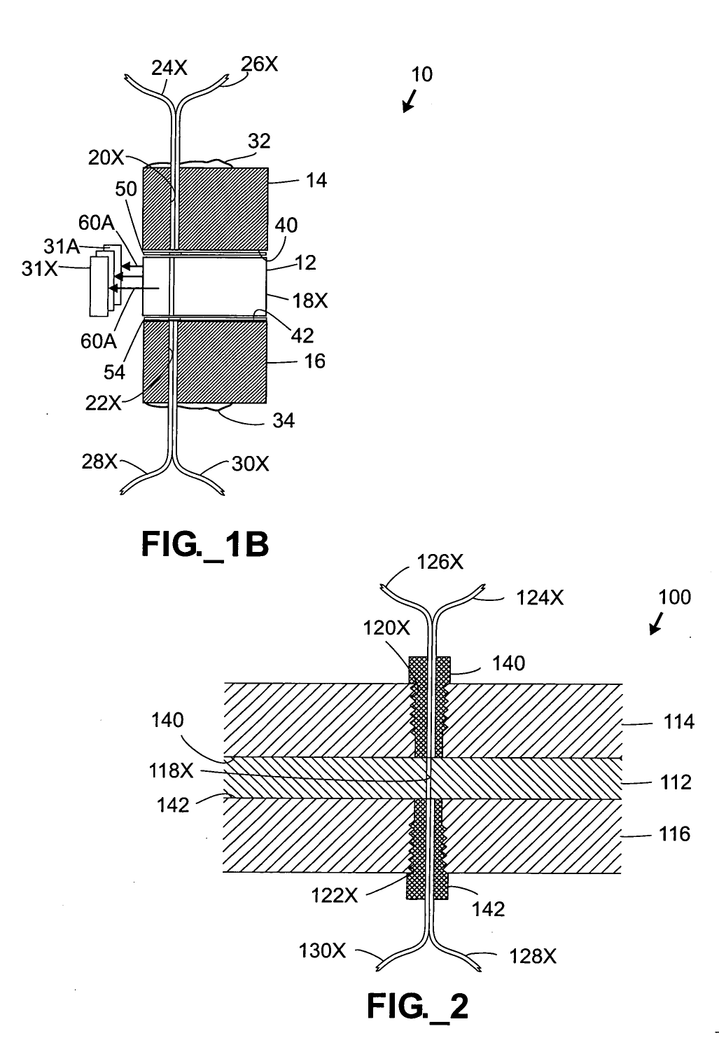

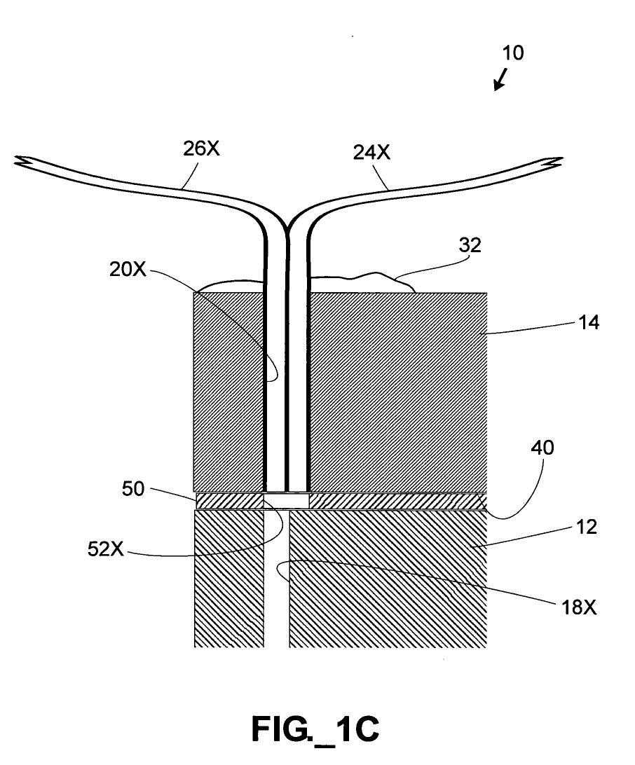

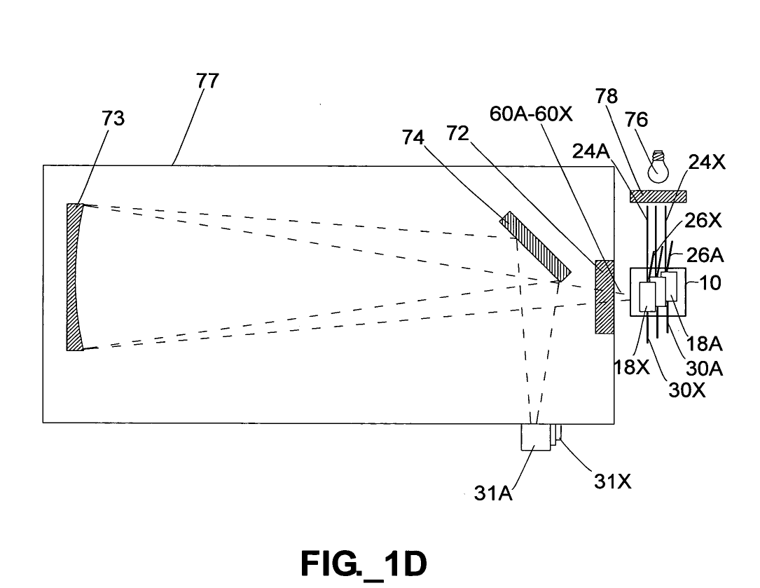

Referring to FIGS. 1A-1C, one example of a capillary multi-channel optical flow cell 10 according to a preferred embodiment includes a flow layer 12 and two end blocks 14, 16.

The flow layer 12 may be fabricated from any materials suitable for and chemically compatible with liquid chromatography and the desired optical detection technique. Suitable materials include, but are not limited to: fluoropolymers, poly(ether ether ketone) (PEEK), fused silica, sapphire, quartz, polyimide, stainless steel, or any other material having a chemically compatible coating.

In the present embodiment and other embodiments discussed below, fluoropolymers (semi-crystalline and amorphous) and perfluoropolymers, including, but not limited to, Teflon® AF (E.I. du Pont de Nemours and Company, Wilmington, Del.), Halar® (Ausimont USA, Thorofare, N.J.), Cytop® (Asahi Glass Company, Charlotte, N.C.), ultra-clear chlorotrifluoroethylene (CTFE), modified fluoro alkoxy (MFA), fluorinated ethylene propylene (FEP), and perfluoroalkoxy (PFA) are particularly suitable for both absorption and fluorescence applications due to their high optical clarity and transmission of a wide spectrum of radiation (typically above 80% transmission of wavelengths over a range of 200 nanometers to 2000 nanometers), a very low refractive index (typically about 1.3), and a durometer (typically between 50 and 90 Shore D) that allows fluid tight seals at operating pressures of up to 500 pounds per square inch (3450 kPa) or more without the need for gaskets or other sealing aids. The selected material may be quenched to enhance clarity. Examples of other suitable materials include, without limitation, UV-grade fused silica, UV-grade quartz, calcium fluoride (CaF), and sapphire.

If the flow cell 10 is to be used for absorbance analysis, both transparent and opaque materials are generally suitable for fabrication of the flow layer 12. Preferably the material is highly reflective or its refractive index is sufficiently low as to reflect enough light internally to allow detection at the desired level of sensitivity. Additionally, opaque materials will reduce cross talk between channels.

If the flow cell 10 is to be used for fluorescence analysis, then the flow layer 12 is preferably fabricated from a substantially optically transmissive, and more preferably transparent, material. Materials having low refractive indices also are desirable to minimize loss of excitation radiation.

The flow layer 12 defines a plurality of flow channels 18A-18X, which serve as the detection regions of the flow cell 10. (Although FIG. 1A shows the flow cell 10 having three flow channels 18A-18X, it will be readily apparent to one skilled in the art that any number of flow channels 18A-18X may be provided. For this reason, the designation “X” is used to represent the last flow channel 18X, with the understanding that “X” represents a variable and could represent any desired number of flow channels. This convention may be used elsewhere within this document.) Each flow channel 18A-18X has an internal diameter that is approximately equal to the internal diameter of the conduits 24A-24X through which the fluid samples to be analyzed are delivered to the flow cell 10. By matching the internal diameters of the flow channels 18A-18X and the conduits 24A-24X, dead volumes or constrictions in the flow path are minimized, thus reducing the potential for band broadening of or other negative effects on the eluate streams.

The length of each flow channel 18A-18X is determined by the thickness 11 of the flow layer 12. In one example, the flow layer 12 is preferably about 0.063 inches (about 1.55 mm) thick. It will be readily apparent to one skilled in the art that flow layers of different thicknesses may be used to increase or decrease the length of the flow channels 18A-18X. Such modifications may be used to increase or decrease the sensitivity of measurements taken using the flow cell 10 or to otherwise vary the performance of the flow cell 10 as may be desired for a particular application.

The end blocks 14, 16 may be fabricated from any materials suitable for and chemically compatible with liquid chromatography. Suitable materials include, but are not limited to: fluoropolymers, PEEK, fused silica, sapphire, quartz, polyimide, stainless steel, or any other material having a chemically compatible coating. Because the optical characteristics of the end blocks 14, 16 do not affect the operation of the flow cell 10, materials exhibiting the broadest range of chemical compatibility and desired structural performance, such as PEEK or stainless steel, are preferred. The end blocks 14, 16 define input ports 20A-20X and output ports 22A-22X, respectively. The input ports 20A-20X and output ports 22A-22X are positioned to correspond to the flow channels 18A-18X when the flow cell 10 is assembled. The input ports 20A-20X and output ports 22A-22X may be oblong or otherwise fashioned in order to receive both optical fibers and fluid conduits when needed, as described below. In a preferred example, the ports 20A-20X, 22A-22X are fabricated by drilling two holes of the appropriate diameter with a slight overlap so that no material is present at the intersection of both holes. This approach permits insertion of conduits and optical fibers into the ports 20A-20X, 22A-22X while minimizing the amount of epoxy or other adhesive and/or sealant required to secure the conduits and optical fibers in position and seal any gaps.

Input fluid conduits 24A-24X are inserted into the input ports 20A-20X, and output fluid conduits 28A-28X are inserted into the output ports 22A-22X. The input fluid conduits 24A-24X and output fluid conduits 28A-28X may be any suitable type of fluid conduit. In one example, the fluid conduits were made with 14.2 mil (about 360 micron) PEEK tubing; however, one skilled in the art will readily appreciate that the selection of conduit size and material will depend on the chemical compatibility and fluid flow rate required for the particular chromatographic process to be performed.

Input optical fibers 26A-26X are inserted into input ports 20A-20X. Output optical fibers 30A-30X may be inserted into output ports 22A-22X. The use of output optical fibers 30A-30X is optional depending on the type of optical detection to be performed. For example, if fluorescence measurement is to be performed, then the output optical fibers 30A-30X may be used to collect the fluorescence emission from the eluate streams. Alternatively, as discussed in more detail below, fluorescence detectors and light collection optics 31A-31X may be positioned to allow detection of fluorescence emissions through the flow layer 12, thus obviating the need for optical fibers 30A-30X. The input optical fibers 26A-26X and output optical fibers 30A-30X may be any suitable type of optical fiber. In one example, approximately 14 mil (about 355 micron) bare optical fiber was used; however, one skilled in the art will readily appreciate that the selection of optical fibers will depend on the chemical compatibility, optical transparency, and transmissibility characteristics required to perform the desired form of optical detection.

It will be readily apparent to one skilled in the art that the internal diameters of the flow channels 18A-18X, the input conduits 24A-24X, and the output conduits 28A-28X may be selected to accommodate the anticipated flow rate of eluate streams through the flow cell 10. Preferably, the internal diameters of the flow channels 18A-18X and the conduits 24A-24X, 28A-28X should be similar to avoid the introduction of dead volume, which might cause detrimental band broadening within the eluate streams. However, in order to ensure the maximum transmission of excitation radiation from the input optical fibers 26A-26X into the flow channels 18A-18X, the input optical fibers 26A-26X are preferably aligned co-axially with the flow channel 18A-18X. Because the flow channels 18A-18X are preferably of substantially the same diameter as the fluid input conduits 24A-24X, the fluid input conduits 24A-24X will necessarily be offset from the flow channels 18A-18X by at least the diameter of the input optical fibers 26A-26X. In order to allow unimpeded eluate flow from the input fluid conduits 24A-24X into the flow channels 18A-18X, a gasket 50 may be positioned between the first end block 14 and the flow layer 12. The gasket 50 defines a plurality of orifices 52A-52X. The orifices 52A-52X may be circular, oval or of any desired shape and are sized to permit unimpeded flow from the input fluid conduits 24A-24X into the flow channels 18A-18X as well as an unimpeded line of sight between the input optical fibers 26A-26X into the flow channels 18A-18X. Alternatively, either the flow layer 12 or the end block 14 may be countersunk (not shown) in the region surrounding the interface between the fluid conduits 24A-24X and the flow channels 18A-18X to provide the desired clearance between the input fluid conduits 24A-24X and the flow channels 18A-18X. In addition, if output optical fibers 30A-30X are used, then the same arrangement of a gasket 54 (or, optionally, countersinks) may be used between the flow layer 12 and the second end block 16.

In a preferred method of assembling the flow cell 10, the fluid conduits 24A-24X, 28A-28X and optical fibers 26A-26X, 30A-30X may be affixed or “potted” within their respective input/output ports 20A-20X, 22A-22X through the use of any suitable adhesive 32, 34, such as high strength epoxy. Once the fluid conduits 24A-24X, 28A-28X and optical fibers 26A-26X, 30A-30X are positioned and affixed or sealed in place (e.g., by curing an epoxy potting material), the ends of the fluid conduits 24A-24X, 28A-28X and optical fibers 26A-26X, 30A-30X are preferably trimmed down to the inner faces 40, 42 of the end blocks 14, 16. The ends of the fluid conduits 24A-24X, 28A-28X; optical fibers 26A-26X, 30A-30X; and inner faces 40, 42 of the end blocks 14, 16 are then polished, preferably such that the ends of the fluid conduits 24A-24X, 28A-28X and optical fibers 26A-26X, 30A-30X are substantially flush with the inner faces 40, 42 of the end blocks 14, 16.

To prevent debris generated by the polishing process from contaminating the interior of the fluid conduits 24A-24X, 28A-28X, the fluid conduits 24A-24X, 28A-28X may be dipped in paraffin, polyethylene glycol or any other suitable material prior to polishing to block the openings thereof. Once the polishing process is complete, the fluid conduits 24A-24X, 28A-28X may be heated to the melting temperature of the selected debris-blocking material, which then flows from the opening. Polyethylene glycol is particularly suitable for this process, as formulations having a wide range of melting temperatures are readily available.

The end blocks 14, 16, gaskets 50, 52, and flow layer 12 are then stacked and aligned and the entire assembly is fastened together using fasteners of any suitable type, such as adhesives, clamps, bolts, or other conventional fasteners.

In operation, the flow cell 10 is placed in fluid communication with a plurality of liquid chromatography columns (not shown) in a manner that directs the eluate from each column through an input fluid conduit 24A-24X. Each input fluid conduit 24A-24X carries an eluate stream into a flow channel 18A-18X for analysis. Each eluate stream flows from a flow channel 18A-18X into an output fluid conduit 28A-28X where it can be delivered to additional flow cells (if, for example, both fluorescence and absorption measurements are desired), analytical instruments (such as a mass spectrometer), discarded as waste, or any combination thereof.

Notably, the flow cell 10 may be used to perform either absorbance or fluorescence analysis. If absorption analysis is performed, then an optical input signal may be delivered to each flow channel 18A-18X via the input optical fibers 26A-26X. The input signal travels through each flow channel 18A-18X and the eluate contained therein. The resulting absorbance (output) signal is then collected via the output optical fibers 30A-30X and communicated to a detector (not shown). In such a configuration, the flow layer 12 may be fabricated with a substantially non-optically transmissive material such as stainless steel or PEEK.

If fluorescence analysis is performed, then an excitation signal may be delivered to the flow channels 18A-18X via input optical fibers 26A-26X. The excitation signal travels through each flow channel 18A-18X and the eluate contained therein. The resulting fluorescence emissions 60A-60X are detected by detectors 31A-31X placed in sensory communication with the flow layer 12 and each flow channel 18A-18X. In such a configuration, the flow layer 12 must be fabricated with a material having sufficient optical clarity and transmission to permit the fluorescence signal to be detected therethrough, such as (but not limited to) quartz, sapphire, or the fluoropolymers discussed above. The sensory communication between the flow channels 18A-18X may be provided by positioning an array of optical fibers (not shown) proximate to the flow layer 12 such that each flow channel 18A-18X is adjacent to at least one such optical fiber.

More preferably, as illustrated in FIG. 1D, the flow cell 10 may be coupled with an excitation source 76, one or more filters 72, 78, a focusing mirror 73, a flat mirror 74, and multiple detectors 31A-31X. Various types of excitation sources 76 may be used, including arc lamps (e.g., mercury or xenon) or lasers (e.g., helium-neon, argon/krypton, or argon ion). The filters 72, 78 may include an excitation interference filter 78 and an emission interference filter (or “barrier filter”) 72. In one example, the filter set is a model XF100-2E fluorescence filter set (Omega Optical, Inc., Brattleboro, Vt.). The detectors 31A-31X may be integrated into a single unit, such as, without limitation, a multi-channel photomultiplier tube, a charge-coupled device, a diode array, and/or a photodiode array. In one example, the multi-channel detector is a multianode photomultiplier tube with an 8×8 anode array, Hamamatsu model H7546B-03 (Hamamatsu Corp., Bridgewater, N.J.). In this configuration, an excitation signal is generated by the excitation source 76. The signal is filtered by the excitation interference filter 78 and carried to the flow channels 18A-18X via the input optical fibers 24A-24X and into the flow cells 18A-18X, thereby stimulating the eluate streams contained therein. Where appropriate, individual eluate streams emit fluorescence signals 60A-60X, which travel through the flow layer 12 and the emission interference filter 72. The fluorescence emissions 60A-60X are then reflected and focused by the focusing mirror 73 and the focused images are directed to the detectors 31A-31X by the flat mirror 74. The focusing mirror 73, which is preferably concave, serves to optically image a sensory portion of each flow channel 18A-18X on a different detector 31A-31X. In one example, the focusing mirror is a model H43-545 concave mirror (Edmund Industrial Optics, Barrington, N.J.). The filters 72, 78, focusing mirror 73, flat mirror 74, detectors 31A-31X, and other components may be housed in an enclosure 77, which may be substantially light tight to minimize stray light from environmental sources. Of course, other optical configurations may be used as desired and suitable to obtain the desired measurements (e.g., including more or less filtering, more or less precise focusing elements, etc.).

In the configuration illustrated in FIG. 1C, output optical fibers are not needed to collect fluorescence signals and may be eliminated from a flow cell 10 intended for fluorescence analysis; however, output optical fibers (e.g., fibers 30A-30X as illustrated in FIGS. 1A-1B) may be left in place to allow the flow cell 10 to be used for absorption analysis in different applications (i.e., to permit the flow cell 10 to be operated in either fluorescence or absorbance modes). Alternatively, fluorescence emissions 60 may be collected via the output optical fibers 30A-30X. In such a configuration, the flow layer 12 may be fabricated from a substantially non-optically transmissive material such as stainless steel or PEEK.

The flow cell 10 provides numerous advantages over the conventional flow cells. For example, the direct coupling of the optical fibers 26A-26X, 30A-30X and fluids in the flow channels 18A-18X minimizes the number of optical interfaces, thus minimizing Fresnel losses. In addition, because the optical fibers 26A-26X, 30A-30X are trimmed and polished to be flush with the inner surfaces 40, 42 of the end blocks 14, 16, in a preferred embodiment, the distance between the ends of the optical fibers 26A-26X, 30A-30X on opposing sides of the flow channels 18A-18X is consistent from flow channel 18A-18X to flow channel 18A-18X. Because variation in the length of the detection regions (the portion of the flow channels 18A-18X between the ends of the optical fibers 26A-26X, 30A-30X) is minimized during assembly, little or no calibration of each channel of the flow cell 10 is required to ensure consistency across all of the channels. Moreover, because the optical fibers 26A-26X, 30A-30X may be trimmed and polished substantially simultaneously, and because each the optical fibers 26A-26X, 30A-30X are preferably polished flush to the same surface (i.e., the inner surfaces 40, 42 of the end blocks 14, 16), precise alignment of the optical fibers 26A-26X, 30A-30X during the potting or other sealing process is not required, substantially simplifying the fabrication process.

The modular construction of the flow cell 10 also provides numerous benefits. As noted above, the fabrication process minimizes the complexity of sealing (e.g., potting) and aligning the optical fibers 26A-26X, 30A-30X (and the fluid conduits 24A-24X, 28A-28X). In addition, the modular construction permits rapid and efficient quality assurance, quality control, servicing, and rapid alteration of path length if desired (e.g., to accommodate a variety of different sample concentrations in eluate streams). For example, if one or more flow channels 18A-18X should become obstructed, contaminated or otherwise unusable, then the flow cell 10 may be disassembled to replace a faulty flow layer 12 a functioning flow layer 12. Also, when analyzing samples at low concentrations in an eluate stream, it is often desirable to use a longer detection region to increase the interaction between the sample and the illumination signal. If a flow cell 10 having longer flow channels 18A-18X is desired, then the flow cell 10 may be disassembled to replace a faulty flow layer 12 with a flow layer (not shown) of a different thickness, thereby increasing or decreasing the length of the flow channels 18A-18X as desired.

Another advantage presented by the flow cell 10 is the reduced space requirements of the flow cell 10 within a workspace. In order to avoid damaging fragile optical fibers 26A-26X, 30A-30X and the fluid conduits 24A-24X, 28A-28X, the bend radii thereof must be limited. As a consequence, conventional Z-shaped flow cells, which typically have optical fibers or fluid conduits protruding from at least four surfaces thereof, must have substantial spatial clearance to permit routing of said fibers and conduits without damaging them. In contrast, the optical fibers 26A-26X, 30A-30X and the fluid conduits 24A-24X, 28A-28X of the flow cell 10 are preferably inserted in pairs and in parallel into the input and output ports 20A-20X, 22A-22X. Thus, the optical fibers 26A-26X, 30A-30X and the fluid conduits 24A-24X, 28A-28X may protrude only from two surfaces of the flow cell 10, thus reducing physical profile of the flow cell 10 and reducing the necessary spacing between the flow cell 10 and other system components.

Although certain advantages of the present invention are described above with reference to the embodiment illustrated in FIGS. 1A-1D, it will be readily apparent to one of ordinary skill in the art that these advantages apply equally to other embodiments, including those described below.

In another embodiment, as shown in FIG. 2, a flow cell 100 may include a flow layer 112, end blocks 114, 116, fluid conduits 124X, 128X and optical fibers 126X, 130X. The fluid conduits 124X, 128X and optical fibers 126X, 130X may be affixed within their respective input/output ports 120X, 122X through the use of threaded fittings, such as, but not limited to, conventional #6-32 threaded fittings. Once the fluid conduits 124X, 128X and optical fibers 126X, 130X are positioned, the inner faces 140, 142 of the end blocks 114, 116 are preferably polished to ensure a flush surface.

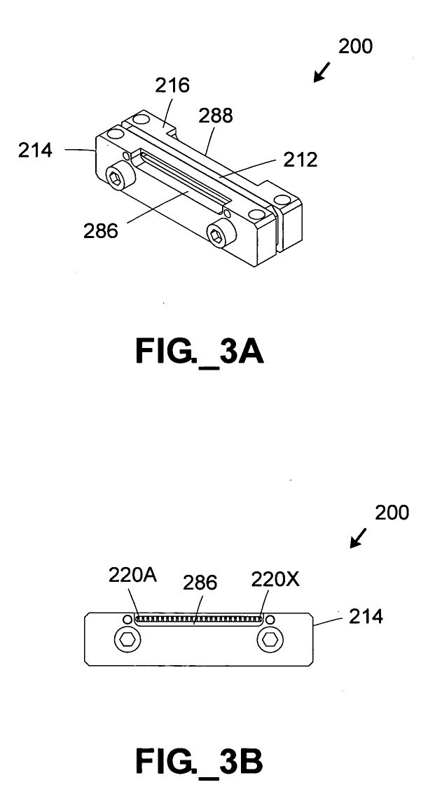

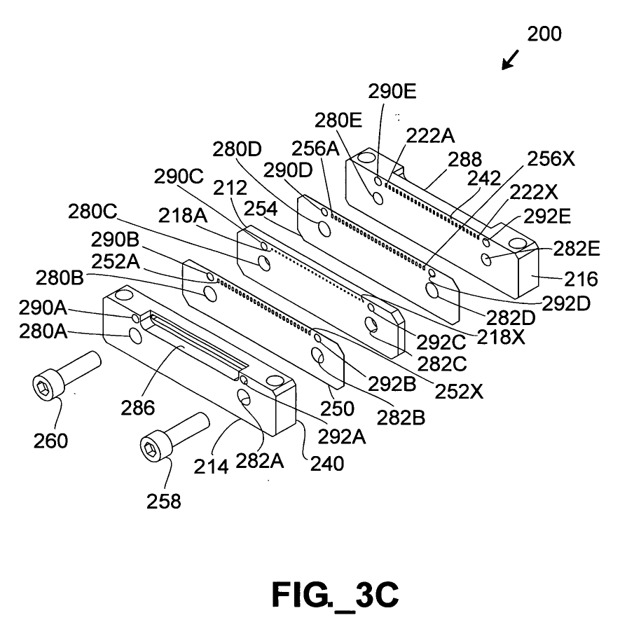

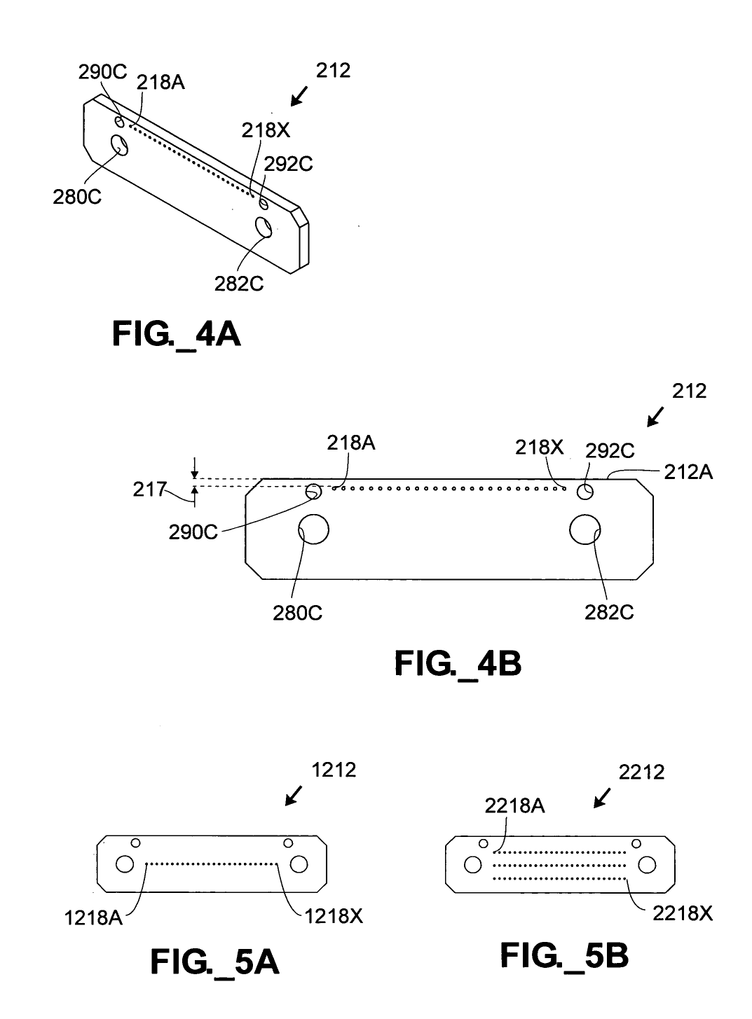

Referring to FIGS. 3A-3C and FIGS. 4A-4B, a capillary multi-channel optical flow cell 200 according to another preferred embodiment includes a flow layer 212 and two end blocks 214, 216. The flow layer 212 may be fabricated from any materials suitable for and chemically compatible with liquid chromatography and the desired optical detection technique. Suitable materials include, but are not limited to: fluoropolymers, poly(ether ether ketone) (PEEK), fused silica, sapphire, quartz, polyimide, stainless steel, or any other material having a chemically compatible coating. If the flow cell 200 is to be used for performing absorption analysis, both substantially transmissive and opaque materials are generally suitable, provided the refractive indices of such materials are sufficiently low as to reflect enough light internally to allow detection at the desired level of sensitivity. If the flow cell 200 is to be used for performing fluorescence analysis, then the flow layer 212 is preferably fabricated from a substantially transparent material. Materials having low refractive indices also are desirable to minimize loss of excitation radiation.

The flow layer 212 defines multiple flow channels 218A-218X. Each flow channel 218A-218X preferably has an internal diameter that is substantially equal to the internal diameter of the associated conduit (not shown) through which fluid samples are delivered to the flow cell 200. The flow layer 212 further defines fastener orifices 280C, 282C and alignment orifices 290C, 292C. The length of each flow channel 218A-218X is determined by the thickness 211 of the flow layer 212. In one example, the flow layer 212 is preferably about 0.063 inches (about 1.549 mm) thick. It will be readily apparent to one skilled in the art that flow layers 212 of different thicknesses may be used to increase or decrease the length of the flow channels 218A-218X. Such modifications may be used to increase or decrease the sensitivity of measurements taken using the flow cell 200 or to otherwise vary the performance of the flow cell 200 as may be desired for a particular application. The flow layer 212 may be fabricated by selecting a sheet or block of the selected material (such as a fluoropolymer) and cutting it into shape using any suitable cutting tool, including, but not limited to, mechanical blades, saws, and lasers. The flow channels 218A-218X are then cut using any suitable tool, including, but not limited to, drills, punches, and lasers.

As illustrated in FIGS. 4A-4B, each flow channel 218A-218X is preferably positioned near an edge 212A of the flow layer 212. The distance 217 between the edge 212A and the flow channels 218A-218X may be selected to minimize any attenuation in fluorescence signals caused by the material properties of the flow layer 212. In one example, the distance 217 is about 0.035 inches (about 0.889 mm).

Alternatively, if a flow cell according to the present invention is to be used for only for absorbance analysis, then the flow channels may be positioned to provide other benefits. For example, as shown in FIG. 5A, a flow layer 1212 may have flow channels 1218A-1218X positioned centrally to reduce manufacturing complexity and increase structural integrity. In another alternative, as shown in FIG. 5B, a flow layer 2212 may have multiple rows of flow channels 2218A-2218X, to further increase the analysis capacity of a flow cell. In both cases, the end blocks (not shown) of a flow cell may be adapted to provide the desired fluid and sensory communication between the flow layers 1212, 2212 and the end blocks 214, 216.

The end blocks 214, 216 may be fabricated from any materials suitable for and chemically compatible with liquid chromatography. Suitable materials include, but are not limited to: fluoropolymers, PEEK, fused silica, sapphire, quartz, polyimide, stainless steel, or any other material having a chemically compatible coating. Because the optical characteristics of the end blocks 214, 216 preferably do not affect the operation of the flow cell 200, materials exhibiting the broadest range of chemical compatibility and desired structural performance, such as PEEK and stainless steel, are preferred. The end blocks 214, 216 define input ports 220A-220X and output ports 222A-222X, respectively. The input ports 220A-220X and output ports 222A-222X are positioned to correspond to the flow channels 218A-218X when the flow cell 200 is assembled. The end blocks 214, 216 further define fastener orifices 280A, 280E, 282A, 282E and alignment orifices 290A, 290E, 292A, 292E.

Recesses 286, 288 may be defined in the outer faces of the end blocks 214, 216 proximate to the input ports 220A-220X and output ports 222A-222X. The recesses 286, 288 permit the application of epoxy or suitable other adhesives, used for securing fluid conduits (not shown) and optical fibers (not shown) within or around the input ports 220A-220X and output ports 222A-222X, without the adhesive protruding outwardly from the flow cell 200 in an obstructive or otherwise undesirable manner.

As discussed previously with regard to the device 10 (illustrated in FIGS. 1A-1C), in the device 200, gaskets 250, 254 may be positioned between the end blocks 214, 216 and the flow layer 212 to allow unimpeded eluate flow from the input fluid conduits (not shown) through the flow channels 218A-218X. Each gasket 250, 254 defines multiple orifices 252A-252X, 256A-256X. The orifices 252A-252X, 256A-256X may be circular, oval or of any desired shape and are sized to permit unimpeded flow from the input fluid conduits into the flow channels 218A-218X as well as an unimpeded line of sight between the input optical fibers (not shown) into the flow channels 218A-218X. Alternatively, either the flow layer 212 or the end blocks 214, 216 may be countersunk to provide the desired clearance between the input fluid conduits 224A-224X and the flow channels 218A-218X. The gaskets 250, 254 further define fastener orifices 280B, 280D, 282B, 282D and alignment orifices 290B, 290D, 292B, 292D.

To assemble the flow cell 200 for operation, the fluid conduits (not shown) and optical fibers (not shown) may be affixed within their respective input/output ports 220A-220X, 222A-222X through the use of any suitable adhesive, such as high strength epoxy. Alternatively, threaded fittings (not shown) may be used to secure the conduits and optical fibers. Once the fluid conduits and optical fibers are positioned, the ends of the fluid conduits and optical fibers are trimmed and the inner faces 240, 242 of the end blocks 214, 216 are polished, preferably ensuring that the ends of the fluid conduits and optical fibers are flush with the inner faces 240, 242 of the end blocks 214, 216. To prevent debris caused by the polishing process from contaminating the interior of the fluid conduits 224A-224X, 228A-228X, the fluid conduits 224A-224X, 228A-228X may be dipped in paraffin, polyethylene glycol or any other suitable material to block the openings thereof. Once the polishing process is complete, the fluid conduits 224A-224X, 228A-228X may be heated to the melting temperature of the selected debris-blocking material, which then flows from the opening. Polyethylene glycol is particularly suitable for this process, as formulations having a wide range of melting temperatures are readily available.

The end blocks 214, 216, gaskets 250, 252, and flow layer 212 are then stacked and aligned. Alignment is achieved by mounting the components 214, 250, 212, 254, 216 on alignment pins (not shown), which protrude through the alignment orifices 290A-290E, 292A-290E. The entire assembly is fastened together using any suitable type of fasteners, such as adhesives, clamps, bolts, or other conventional fasteners. Preferably, bolts 258, 260 are positioned through the fastener orifices 280A-280E, 282A-282E while the assembly is mounted on the alignment pins (not shown) so the entire flow cell 200 may be fastened together when the components 214, 250, 212, 254, 216 are aligned. In additions, the fastener orifices 280E, 282E in the end block 216 may be threaded to allow the bolts 258, 260 to be affixed thereto.

In operation, the flow cell 200 is placed in fluid communication with a plurality of liquid chromatography columns (not shown) in a manner that directs the eluate from each column through an input fluid conduit (not shown). Each input fluid conduit (not shown) carries the eluate into a flow channel 218A-218X for analysis. Each eluate stream flows from the flow channel 218A-218X into an output fluid conduit (not shown) where it can be delivered to additional analytical instruments (not shown), such as a mass spectrometer, or discarded as waste. Fluorescence and/or absorption measurements may be obtained as described above with respect to FIGS. 1A-1D.

The use of multiple flow channels in a single flow layer, as illustrated in the preceding examples, may result in detrimental cross-talk or backscatter, either of which may interfere with the measurements being obtained by the detector. Cross-talk may arise when radiation emitted from one flow channel travels through the flow layer and enters a second flow channel. Some of this errant signal may then be reflected by the walls of the second flow channel into the sensory path of the detector for the second flow channel, thereby corrupting the measurement obtained by that detector. Backscatter may occur when radiation emitted from one flow channel travels through the flow layer and is reflected by a boundary of the flow layer (such as the rear edge) and reflected back through the flow channel into the sensory path of the detector associated therewith.

In the case of either cross-talk or backscatter, the precision and accuracy of the measurements obtained by the detector associated with one or more of the channels may be degraded. These negative effects may increase if the density of the flow channels is increased or the overall geometry of the flow layer is modified. While cross-talk and backscatter typically are not of sufficient magnitude to affect the precision or accuracy of the illustrated embodiments of the invention, these effects may be reduced by using one or more opaque or absorptive elements to block errant signals within the flow layer.

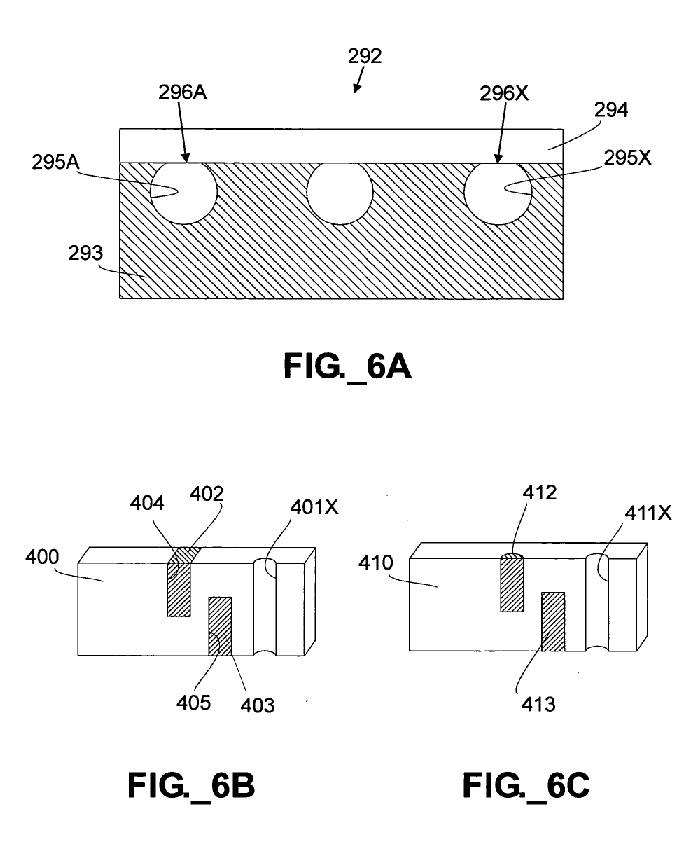

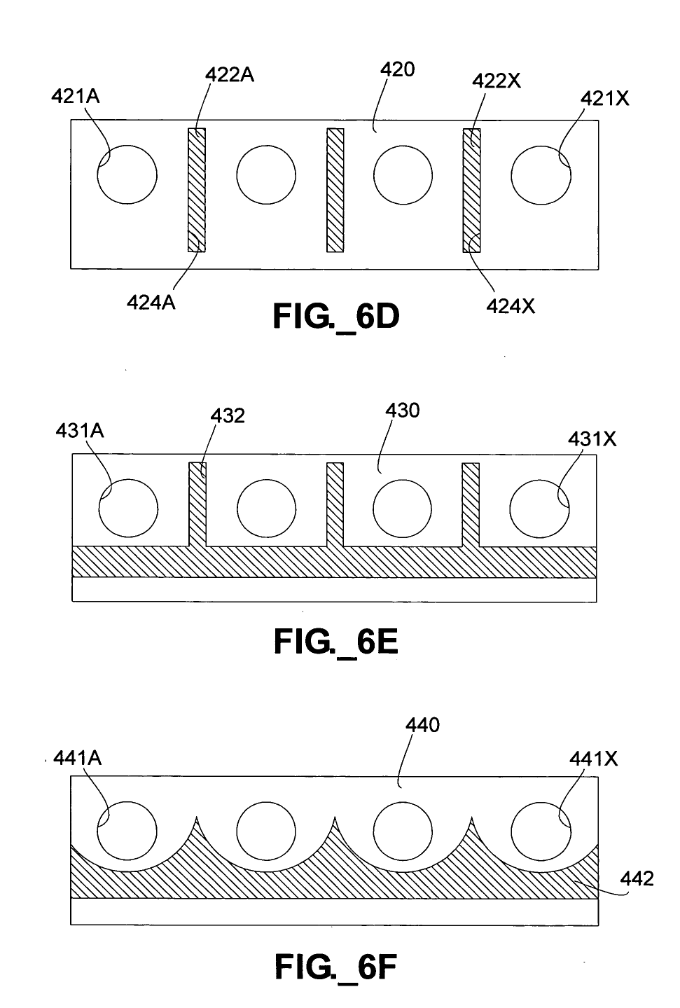

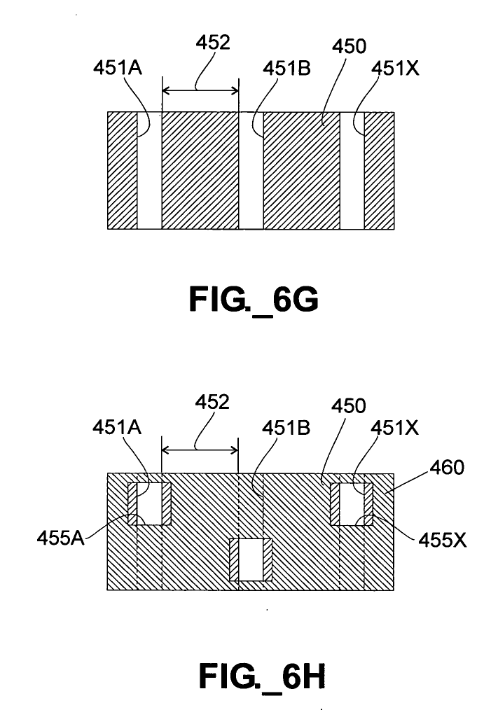

In one embodiment, illustrated in FIG. 6A, a flow layer 292 includes a channel component 293 and a window component 294. Flow channels 295A-295X are defined in the channel component 293. The flow channels 295A-295X may be formed by: drilling, resulting in channels having a substantially circular cross-section (as shown); routing, resulting in channels having a square or rectangular cross-section (not shown); etching; or any other suitable manufacturing process. The flow channels 295A-295X are formed along one edge of the channel component 293 to define an aperture 296A-296X for each flow channel. The window component 294 is then affixed to the channel component 293, enclosing the flow channels 295A-295X along the apertures 296A-296X. The channel component 293 may comprise an opaque, reflective, or absorptive material, thereby preventing radiation from traveling between the flow channels 295A-295X or through other areas of the flow layer 292. The absorptive or opaque material preferably absorb ore blocks radiation throughout wavelength range of the detector (e.g., 200 nm to 1100 nm). Because radiation may only be emitted through the apertures 296A-296X along the sensory path of the detectors (not shown), cross-talk and backscatter are substantially reduced or eliminated.

In another embodiment, illustrated in FIG. 6B, a substantially optically transmissive or transparent flow layer 400 includes a flow channel 401X and one or more backscatter shields 402, 403. The backscatter shields 402, 403 may be inserted into wells 404, 405 defined in the flow layer 400. The backscatter shields 402, 403 are comprised of any suitable opaque or absorptive material, which may be solid prior to insertion into the wells 404, 405. Alternatively, the backscatter shields 402, 403 may comprise a liquid that solidifies or is cured after introduction into the wells 404, 405. If the material used to fabricate the flow layer 400 is structurally weak, then it may be desirable to provide the backscatter shields 402, 403 in the manner illustrated, that is, staggered with one shield 402 separated from the second shield 403 by a distance sufficient to preserve the structural integrity of the flow layer 400. Because the backscatter shields 402, 403 each extend through at least half the depth of the flow layer 400, the entire region behind the flow channel 401X is shielded. Of course, in structurally robust materials, a single backscatter shield (not shown) may extend through the entire depth of the flow layer 400. In operation, radiation emanating from the flow channel 410X in the direction of the backscatter shield is blocked or absorbed by the backscatter shields 402, 403, thereby minimizing or eliminating any backscatter of the signal.

In another embodiment, illustrated in FIG. 6C, a flow layer 410 includes one or more cylindrical backscatter shields 412, 413. The use of cylindrical backscatter shields 412, 413 further minimizes the volume occupied by the shields 412, 413, simplifying the manufacture of the flow layer 410 and improving the structural stability thereof. Furthermore, in the event any radiation is reflected by the shields, the cylindrical shape of the shields 412, 413 will tend to disperse radiation laterally, rather than reflecting it directly back through the flow channel 411X. As in the embodiment described in FIG. 6B, the shields 412, 413 may be split and staggered to improve structural stability (as shown) or may comprise a single cylindrical element extending through the entire depth of the flow layer 411X (not shown).

In another embodiment, illustrated in FIG. 6D, a substantially transmissive or transparent flow layer 420 includes multiple flow channels 421A-421X and multiple cross-talk shields 422A-422X. The cross-talk shields 422A-422X may be inserted into wells 424A-424X defined in the flow layer 420. The cross-talk shields 422A-422X may comprise any suitable opaque or absorptive material, which may be solid prior to insertion into the wells 424A-424X. Alternatively, the cross-talk shields 422A-422X may comprise a liquid that solidifies or is cured after introduction into the wells 424A-424X. As in the embodiment described in FIG. 6B, the cross-talk shields 422A-422X may be split and staggered to improve structural stability (not shown) or may comprise a single cylindrical element extending through the entire depth of the flow layer 420 (as shown). In operation, radiation emanating from the flow channels 421A-421X is blocked or absorbed by the cross-talk shields 422A-422X before entering adjacent flow channels 421A-421X, thereby minimizing or eliminating cross-talk.

Of course, cross-talk shields and backscatter shields may be combined. As illustrated in FIG. 6E, a substantially transmissive or transparent flow layer 430 comprises multiple flow channels 431A-431X and a combined shield 432. The combined shield 432 may be a comb-like structure molded into the flow layer 430 during its fabrication or assembled from individual components. Likewise, a staggered construction, as described above, may be used (not shown). In operation, the combined shield 432 acts to minimize or eliminate both cross-talk and backscatter. In an alternate embodiment, as shown in FIG. 6F, a combined shield 442 in a substantially transmissive or transparent flow layer 440 may be scalloped to provide the desired shielding utility. Other geometric configurations and fabrication techniques will be readily apparent to one of ordinary skill in the art.

It also would be desirable to minimize the distance between flow channels to take advantage of the small pixel width and high resolution of charge-coupled devices (CCDs). For example, referring to FIGS. 6G-6H, a flow layer 450 includes multiple flow channels 451A-451X having an inter-channel spacing 452. The theoretical minimum size of the inter-channel spacing 452 is the lesser of the diffraction limit associated with the wavelength being measured by the detector or the pixel width/resolution of the detector; however, this limit may be difficult to achieve due to cross-talk between flow channels 451A-451X that may arise even if the previously described shields are used.

In one embodiment, illustrated in FIG. 6H, a substantially opaque or absorptive mask 460 may be applied to the flow layer 450. Windows 455A-455X are defined in the mask to permit a portion of the flow channels 451A-451X to remain visible to its associated detector (not shown). The mask 460 may be applied by painting, screening, photolithography, vapor deposition, or any other suitable coating technique. The windows 455A-455X are staggered vertically; thus, any radiation dispersing laterally from one channel 451A-451X will not interact with radiation emanating from an adjacent channel 451A-451X due to the offset or staggering of the windows 455A-455X. In this manner, the lateral inter-channel distance 452 may be minimized.

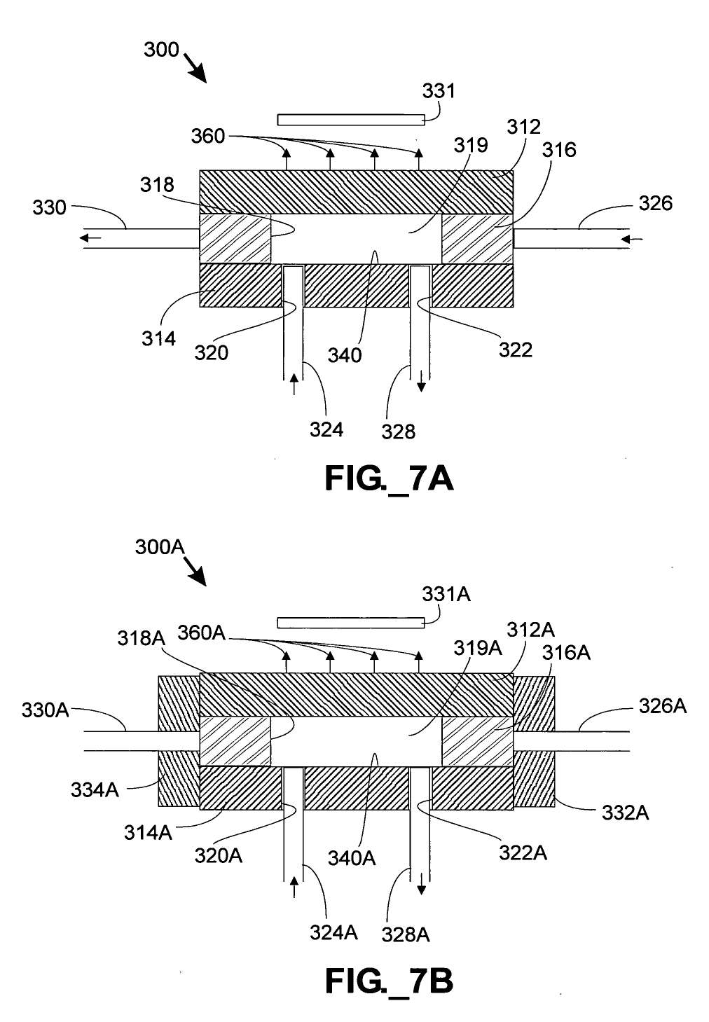

Referring to FIG. 7A, a capillary multi-channel optical flow cell 300 according to another embodiment includes a first outer layer or end block 314, a second outer layer or end block 312, and an intermediate flow layer 316, with fluidic conduits 324, 328 interfaced to the first end block 314 and with optical conduits 326, 330 interfaced to the flow layer 316. While only a single flow channel 318 and detection chamber 319 are shown (permitting the analysis of a single fluid stream), it is to be understood that the flow cell 300 is intended to include multiple flow channels/detection chambers disposed in parallel for analyzing multiple fluid streams simultaneously, with each flow channel 318 having an associated input fluid conduit 324, output fluid conduit 328, input optical fiber 326, and (if desired, e.g., for performing absorbance analyses with a detector located remotely relative to the flow cell 300) output optical fiber 330.

The first outer layer 314 may be fabricated from any materials suitable for and chemically compatible with liquid chromatography. Suitable materials for the second outer layer 314 include, but are not limited to: fluoropolymers, PEEK, fused silica, sapphire, quartz, polyimide, stainless steel, or any other material having a chemically compatible coating. Because the optical characteristics of the second outer layer 314 do not affect the operation of the flow cell 300, materials exhibiting the broadest range of chemical compatibility and desired structural performance, such as PEEK or stainless steel, are preferred. The first outer layer 314 defines an input port 320 and an output port 322. The input port 320 and output port 322 are preferably positioned to be proximate to either end, respectively, of the flow channel 318 when the flow cell 300 is assembled.

The flow layer 316 may be fabricated from any materials suitable for and chemically compatible with liquid chromatography and the desired optical detection technique. Suitable materials include, but are not limited to: fluoropolymers, fused silica, sapphire, and quartz. In one embodiment, the flow layer 316 may be fabricated with a substantially transmissive or transparent material. Materials having low refractive indices also are desirable to minimize scatter and loss of excitation radiation. The flow layer 316 defines a flow channel 318, which, when the flow layer 316 is positioned between the first outer layer 314 and the second outer layer 312, forms a detection chamber 319. Alternatively, the detection chamber 319 may be formed by defining a well (not shown) in either the first outer layer 314 or, more preferably, the second outer layer 312 to create the desired geometry, such that the flow layer 316 is integral to the (e.g., second) outer layer. In either case, the component defining the detection chamber 319 is preferably fabricated from a substantially transmissive or transparent material. Alternatively, if desired, the flow layer 316 may be fabricated from an opaque material (e.g., to prevent cross-talk between adjacent detection chambers 319 of the multi-channel flow cell 300) with the optical fibers 326, 330 penetrating through the flow layer 316 to be in optical communication with the detection chamber 319. The dimensions (e.g., length) of the flow channel 318 may be increased or decreased as desired to increase or decrease the sensitivity of measurements taken using the flow cell 300 or to otherwise vary the performance of the flow cell 300 as may be suitable for a particular application.

The second outer layer 312 may be fabricated from any materials suitable for and chemically compatible with liquid chromatography and the desired optical detection technique. Suitable flow layer materials include, but are not limited to: fluoropolymers, poly(ether ether ketone) (PEEK), fused silica, sapphire, quartz, polyimide, stainless steel, or any other material having a chemically compatible coating. When the flow cell 300 is to be used for performing absorbance analysis, both transparent and opaque materials may be generally suitable for fabricating the second outer layer 312, provided the refractive indices of such materials are sufficiently low as to reflect enough light internally to allow detection at the desired level of sensitivity. When the flow cell 300 is to be used for performing fluorescence analysis, then the second outer layer 312 is preferably fabricated from a substantially optically transmissive or transparent material. Materials having low refractive indices also are desirable to minimize loss of excitation radiation. Furthermore, because the second outer layer 312 may not be structurally supported on one side, stiffer materials suitable for the anticipated operating pressures (e.g., up to five hundred pounds per square inch or more) are preferred.

An input fluid conduit 324 is inserted into the input port 320, and an output fluid conduit 328 is inserted into the output port 322. The input fluid conduit 324 and output fluid conduit 328 may be any suitable type of fluid conduit. In one example, 14.2 mil (about 360 micron) PEEK tubing was used; however, one skilled in the art will readily appreciate that the selection of conduit size and material will depend on the chemical compatibility and fluid flow rate required for the particular chromatography to be performed.

To assemble the flow cell 300 for operation, the fluid conduits 324, 328 may be affixed within their respective input/output ports 320, 322 through the use of any suitable adhesive, such as high strength epoxy. Alternatively, threaded fittings (not shown), compression fittings, or equivalent attachment elements may be used to secure the conduits 324, 328. Once the fluid conduits 324, 328 are positioned, the ends of the fluid conduits 324, 328 are trimmed and the inner face 340 of the second outer layer 314 is polished, preferably ensuring that the ends of the fluid conduits 324, 328 are flush with the inner face 340 of the second outer layer 314. To prevent debris caused by the polishing process from contaminating the interior of the fluid conduits 324, 328, the fluid conduits 324, 328 may be dipped in paraffin, polyethylene glycol or any other suitable material to block the openings thereof. Once the polishing process is complete, the fluid conduits 324, 328 may be heated to the melting temperature of the selected debris-blocking material, which then flows from the opening. Polyethylene glycol is particularly suitable for this process, as formulations having a wide range of melting temperatures are readily available. The second outer layer 314, flow layer 316 and first outer layer 312 are then stacked and aligned. The entire assembly is fastened together using fasteners of any suitable type, such as adhesives, clamps, bolts, or other conventional fasteners.

It will be readily apparent to one skilled in the art that the internal diameters of the flow channel 318 and the input and output conduits 324, 328 may be selected to accommodate the anticipated flow rate of eluate streams through the flow cell 300. Preferably, the internal diameters of the flow channel 318 and the conduits 324, 328 should be similar to avoid the creation of unnecessary dead volumes, which might cause detrimental band broadening within the eluate streams. While FIG. 7A illustrates a flow cell 300 having only one detection chamber 319, it will be readily appreciated by one skilled in the art that multiple detection chambers disposed in parallel are preferably included in a single flow cell 300.

In operation, the flow cell 300 is placed in fluid communication with a liquid chromatography column (not shown) in a manner that directs an eluate from the column through an input fluid conduit 324. The input fluid conduit 324 carries the eluate into the flow channel 318 (that serves as a detection chamber 319) for analysis. The eluate flows from the flow channel 318 into an output fluid conduit 328 where it can be delivered to additional analytical instruments (not shown), such as a mass spectrometer, or discarded as waste.

If the device 300 is used for absorbance analysis, then the absorbance signals are collected via output optical fiber 330 placed opposite the input optical fiber 326 and communicated to a detector (not shown). To perform the desired analysis, an optical signal is delivered to the flow channel 318 via an input optical fiber 326 positioned proximate to or penetrating a first side of the flow layer 316. Similarly, the output optical fiber 330 may be positioned proximate to or penetrating a second opposing side of the flow layer 316.

If the device 300 is used solely for fluorescence analysis, then the fluorescence emissions 360 are detected by a detector 331 placed proximate to the outer layer 312, and the output optical fibers 330 are not needed. Alternatively, fluorescence output optical fibers (not shown) may be positioned proximate to or penetrating the outer layer 312 to collect the fluorescence emissions 360 and communicate them to a remote detector (not shown). In another alternative, optics such as those illustrated in FIG. 1D may be used in conjunction with the flow cell 300 to obtain the desired measurements.

One advantage of the device 300 is that it may be configured to facilitate substantially simultaneous absorbance and fluorescence analyses of flowing samples in each flow channel 318. Each input optical fiber 326 may be used to supply absorbance and excitation radiation to each flow channel 318. To avoid potential interference between absorbance and fluorescence analyses, each input signal may be periodically pulsed to provide different wavelengths at different times to its corresponding flow channel 318, or multiple frequencies may be multiplexed for the desired effect.

In another embodiment, a multi-channel flow cell may include at least one optical conduit termination block. Referring to FIG. 7B, a flow cell 300A substantially similar to the flow cell 300 (illustrated in FIG. 7A) includes optical conduit termination blocks 332A, 334A disposed adjacent to the flow layer 316A. One advantage of such optical conduit termination blocks 332A, 334A is that they permit multiple optical conduits 332A, 334A to be terminated and polished substantially flush against inner surfaces of such blocks 332A, 334A simultaneously, thus greatly simplifying the fabrication of highly parallel flow cells 300A. If the flow cell device 300A is to be used exclusively for fluorescence detection, then the second optical conduit termination block 334A and associated optical conduit(s) 330A may be eliminated.

As before, the flow cell 300A includes a first outer layer or end block 314A, a second outer layer or end block 312A, and an intermediate flow layer 316A disposed between the first outer layer 314A and the second outer layer 312A. Fluidic conduits 324A, 328A are interfaced to the first end block 314A via ports 320A, 322A. The flow layer 316A is disposed between the outer layers 314A, 312A along two opposing surfaces of the flow layer 316A, and further disposed between the optical conduit termination blocks 332A, 334A along two other opposing surfaces of the flow layer 316A. At least the portions of the flow layer 316A bounding each flow channel 318A or detection chamber 319A are preferably substantially optically transmissive or transparent to permit optical coupling between the optical conduits 326A, 330A and the contents of the detection chamber 319A. An optional fluorescence detector 331A may be disposed adjacent to the flow cell 300A, with at least a portion of the second outer layer 312A being substantially optically transmissive in such an instance to permit fluorescence emissions 360A to reach the detector 331A.

Preferred high throughput analytical systems are adapted to perform multiple substantially simultaneous analytical processes, each on different samples of a group of samples. For example, sample streams may be provided in parallel to multiple separation columns. The resulting eluate streams are preferably provided in parallel to a multi-channel optical flow cell for fluorescence detection or absorption detection. Optionally, a second downstream detector may be included (e.g., to allow the system to provide both fluorescence and absorption detection). Still further detection such as mass spectrometric analyses may be performed.

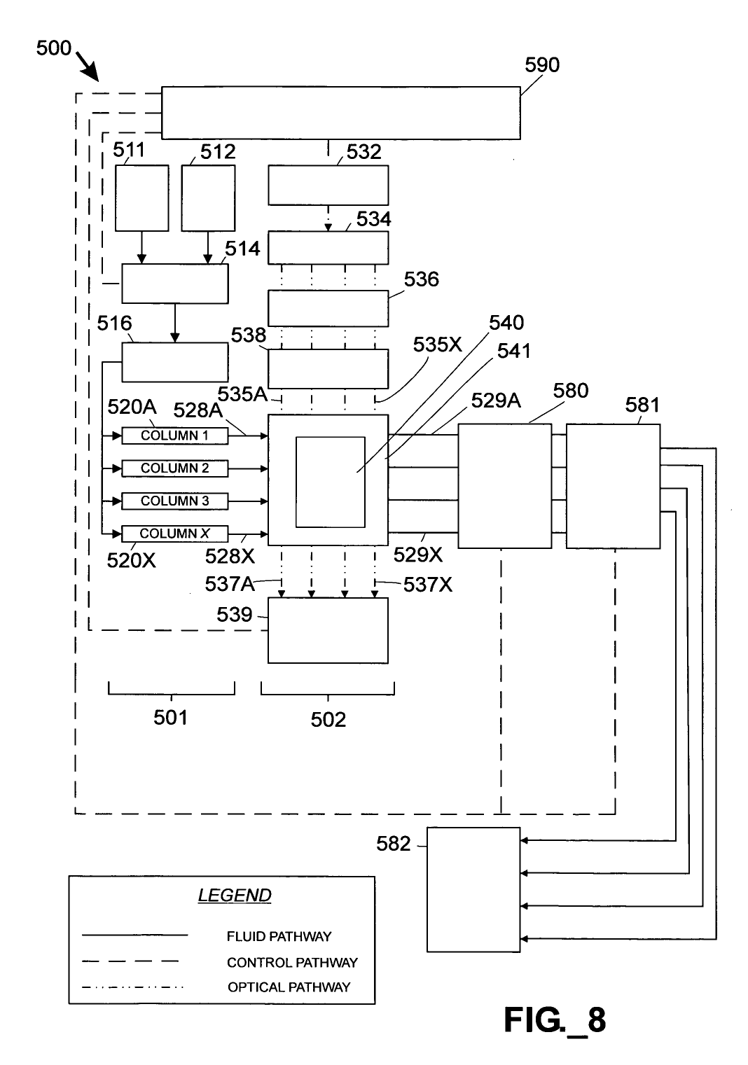

Referring to FIG. 8, any of the preceding flow cells 10, 100, 200, 300 may be utilized in a high throughput analytical system 500. The system 500 includes a system controller 590, a separation subsystem 501, and at least one optical detection subsystem 502 (which incorporates a flow cell 540). The system 500 may further include optional detection elements 580, 581 such as may utilize consumptive or destructive analytical techniques such as MALDI or mass spectrometric analyses. Although FIG. 8 shows two optional detection elements 580, 581, one skilled in the art will readily recognize that any number of optional detection elements may be used as appropriate for the particular application. Eluate may be further or otherwise directed to eluate collection or waste elements 582.

The system controller 590 may include any suitable control device or system, including, but not limited to a conventional personal computer or other general processing unit. The separation subsystem 501 may comprise multiple conventional HPLC systems; integrated parallel HPLC systems, such as the Veloce™ micro-parallel liquid chromatography system (Nanostream, Inc., Pasadena, Calif.); or any other system comprising multiple analytical process regions, i.e., any region adapted to perform a chemical or biochemical analytical process such as chromatographic, electrophoretic, electrochromatographic, immunoaffinity, gel filtration, and/or density gradient separation. The separation subsystem 501 includes fluid reservoirs 511, 512, a fluid supply system 514, a sample injector 516, and multiple chromatographic separation columns 520A-520X.

The optical detection subsystem 502 includes a flow cell 540, a light proof enclosure 541, an excitation source 532, optical elements 534, 538, and filters 536. The flow cell 540 is preferably disposed within a light-proof enclosure 541 to reduce (i.e., preferably eliminate) background interference. If the flow cell 540 is to be used for fluorescence analysis, then the subsystem 502 may include an excitation source 532, optical elements 534, at least one interference filter 536, optional additional optical elements 538 (possibly including a fiber optic interface), a multi-channel optical flow cell 540, and a multi-channel photodetector 539. Various types of excitation sources 532 may be used, including arc lamps (e.g., mercury or xenon) or lasers (e.g., helium-neon, argon/krypton, or argon ion). Optical conduits (e.g., fiber optic conduits) with appropriate interfaces are preferably disposed between the excitation source 532 and optical elements 534 and filters 536. The filters 536 preferably include an excitation filter, a dichroic beamsplitter (or “dichroic mirror”) and an emission filter (or “barrier filter”). In one example, the filter set is a model XF100-2E fluorescence filter set (Omega Optical, Inc., Brattleboro, Vt.). The detector 539, which preferably has multiple sensors, may include, without limitation, one or more multi-channel photomultiplier tubes, charge-coupled devices, diode arrays, and/or photodiode arrays. In one example, the multi-channel detector 539 is a multianode photomultiplier tube with an 8×8 anode array, Hamamatsu model H7546B-03 (Hamamatsu Corp., Bridgewater, N.J.). If a multi-channel photomultiplier tube utilizes a common resistor network, then, if desired, a reference signal may be provided to one or more reference channels of the multi-channel detector to correct signals received from the detection regions for loading effects caused by the common resistor network.

If the flow cell 540 is to be used for absorbance analysis, then the detection subsystem 502 preferably includes a radiation source 532, at least one optical element 534, filters 536, a fiber interface or other optical element 538, and a detector 539. The radiation source 532 supplies radiation to the flow cell 540 through the optical element 534 and filters 536, optical element 538, and optical conduits 535A-535X. The radiation source 532 is preferably a broadband emission UV source, such as a deuterium lamp or arc lamp. The optical element 534 and filters 536 may include multiple discrete wavelength filters (e.g., optical filters), wavelength dispersion elements (such as prisms or diffraction gratings) or monochromators. The multi-channel detector 539 is in optical communication with each of the detection regions by additional optical conduits. The multi-channel detector 539 may include a multi-channel PMT, CCD, diode array, and/or photodiode array. One or common reference signals may be provided to the detector 539. In one example, the radiation source is a deuterium lamp (model L6565-50, Hamamatsu Corp., Bridgewater, N.J.), the wavelength selection element is a CVI Laser model AB301-T filter wheel (Spectral Products, Putnam, Conn.), and the multi-channel detector 539 is a multianode photomultiplier tube with an 8×8 anode array, Hamamatsu model H7546B-03 (Hamamatsu Corp., Bridgewater, N.J.). The radiation source 532 may include a dedicated power supply (not shown). In one example, the power supply is a Hamamatsu model HC 302-2510 (Hamamatsu Corp., Bridgewater, N.J.).

In operation, multiple parallel chromatographic separations are performed using the separation subsystem 501. An eluate stream from each column 520A-520X is transferred to the flow cell 540 via a different fluid conduit 528A-528X. As the eluate streams pass through the flow cell 540, the radiation (for absorption measurements) or excitation (for fluorescence measurements) source 532 delivers the appropriate input signal to the flow cell 540 via optical fibers 535A-535X. The input signal may be modified as necessary for the particular application by the use of optical elements 534, 538 and filters 536. The signal to be measured is collected by the detector 539, either sensed directly or via optical fibers 537A-537X and stored for analysis by the system controller 590. The eluate streams exit the flow cell 540 via fluid conduits 529A-529X and may be delivered to additional detection subsystems 580, 581 and are eventually collected for storage or discarded as waste in a receptacle 582.

While only four columns 520A-520X are illustrated, it will be readily apparent to one skilled in the art that the system 500 may be readily scaled to include components—preferably common components—to perform virtually any number of simultaneous analyses. The system 500 thus permits a large number of samples to be analyzed with a variety of detection technologies without the need for moving parts to translate or otherwise move flow cells or detectors relative to one another.

It is also to be appreciated that the foregoing description of the invention has been presented for purposes of illustration and explanation and is not intended to limit the invention to the precise manner of practice herein. For example, while the foregoing description addresses use of the invention for obtaining fluorescence and absorption measurements, embodiments of the invention are suitable for use in performing other optical analyses of samples, including, but not limited to, Raman spectroscopy. It is to be appreciated therefore, that changes may be made by those skilled in the art without departing from the spirit of the invention and that the scope of the invention should be interpreted with respect to the following claims.

1. A method for fabricating a multi-channel flow cell, the method comprising the steps of:
providing a first end block having a first inner surface and defining a plurality of inlet ports;
providing a second end block having a second inner surface and defining a plurality of outlet ports;
providing a first flow layer defining a first plurality of flow channels and having a first thickness;
inserting a first plurality of optical fibers through the plurality of inlet ports;
inserting a first plurality of fluid conduits through the plurality of inlet ports;
sealing the first plurality of optical fibers and the first plurality of fluid conduits;
polishing the first plurality of optical fibers;
positioning the first flow layer between the first inner surface and the second inner surface; and
directly or indirectly joining the first flow layer, the first end block, and the second end block.

2. The method of claim 1 wherein the sealing step includes potting with a sealant.

3. The method of claim 1 wherein any inlet port of the plurality of inlet ports contains both an optical fiber of the first plurality of optical fibers and a fluid conduit of the first plurality of fluid conduits.

4. The method of claim 1, further comprising the step of trimming the first plurality of optical fibers substantially flush with the first inner surface.

5. The method of claim 1 wherein the polishing step is performed by polishing all of the optical fibers of the first plurality of optical fibers substantially simultaneously.

6. The method of claim 1, further comprising the steps of:
inserting a second plurality of optical fibers into the plurality of outlet ports;
inserting a second plurality of fluid conduits into the plurality of outlet ports;
sealing the second plurality of optical fibers and the second plurality of fluid conduits; and
polishing the second plurality of optical fibers.

7. The method of claim 6 wherein any outlet port of the plurality of outlet ports contains both an optical fiber of the second plurality of optical fibers and a fluid conduit of the second plurality of fluid conduits.

8. The method of claim 6, further comprising the step of trimming the second plurality of optical fibers substantially flush with the second inner surface.

9. The method of claim 6 wherein the polishing step is performed by polishing all of the optical fibers of the second plurality of optical fibers substantially simultaneously.

10. The method of claim 1, further comprising the steps of:
inserting a second plurality of fluid conduits into the plurality of outlet ports;
sealing the second plurality of fluid conduits; and
trimming the second plurality of fluid conduits substantially flush with the second inner surface.

11. The method of claim 1, further comprising the steps of:
providing a second flow layer having a second thickness;
separating the first flow layer, the first end block, and the second end block;
positioning the second flow layer between the first inner surface and second inner surface; and
joining the second flow layer, the first end block, and the second end block.

12. The method of 11 wherein the first thickness differs from the second thickness.

13. The method of claim 1, further comprising the steps of:
providing a first gasket defining a first plurality of orifices; and
positioning the first gasket between the first inner surface and the first flow layer.

14. The method of claim 13, further comprising the steps of:
providing a second gasket defining a second plurality of orifices; and
positioning the second gasket between the second inner surface and the first flow layer.

15. A multi-channel optical flow cell comprising:
a first end block having a first inner surface and defining a plurality of inlet ports;
a flow layer having a first outer surface, having a second outer surface, and defining a plurality of flow channels;
a second end block having a second inner surface and defining a plurality of outlet ports;
a first plurality of optical fibers; and
a first plurality of fluid conduits;
wherein each optical fiber of the first plurality of optical fibers is terminated substantially flush with the first inner surface and is affixed within a different inlet port of the plurality of inlet ports;
wherein each fluid conduit of the first plurality of fluid conduits is terminated substantially flush with the first inner surface and is affixed within a different inlet port of the plurality of inlet ports;
wherein the flow layer is disposed between the first end block and the second end block;
wherein each fluid conduit of the first plurality of fluid conduits is in fluid communication with a different flow channel of the plurality of flow channels; and
wherein each optical fiber of the first plurality of optical fibers is in optical communication with a different flow channel of the plurality of flow channels.

16. The flow cell of claim 15, further comprising:
a second plurality of optical fibers; and
a second plurality of fluid conduits;
wherein each optical fiber of the second plurality of optical fibers is terminated substantially flush with the second inner surface and is affixed within a different outlet port of the plurality of outlet ports;
wherein each fluid conduit of the second plurality of fluid conduits is terminated substantially flush with the second inner surface and is affixed within a different outlet port of the plurality of outlet ports;
wherein each fluid conduit of the second plurality of fluid conduits is in fluid communication with a different flow channel of the plurality of flow channels; and
wherein each optical fiber of the second plurality of optical fibers is in optical communication with a different flow channel of the plurality of flow channels.

17. The flow cell of claim 15, further comprising:
a second plurality of fluid conduits;
wherein each fluid conduit of the second plurality of fluid conduits is terminated substantially flush with the second inner surface and is affixed within a different outlet port of the plurality of outlet ports; and
wherein each fluid conduit of the second plurality of fluid conduits is in fluid communication with a different flow channel of the plurality of flow channels.

18. The flow cell of claim 15, further comprising a first gasket defining a plurality of orifices disposed between the first inner surface and the first outer surface.

19. The flow cell of claim 15, further comprising a second gasket defining a plurality of orifices disposed between the second inner surface and the second outer surface.

20. The flow cell of claim 15 wherein the flow layer comprises any of: a fluoropolymer, a perfluropolymer, poly(ether ether ketone), fused silica, sapphire, quartz, polyimide, and stainless steel.

21. The flow cell of claim 15 wherein at least a portion of the flow layer is substantially optically transmissive.

22. The flow cell of claim 15 wherein at least a portion of the flow layer transmits at least about eighty percent of radiation wavelengths between about 200 nanometers and about 2000 nanometers.

23. The flow cell of claim 15 wherein at least a portion of the flow layer has a refractive index less than or equal to about 1.3.

24. A high-throughput analytical system comprising:
the flow cell of claim 15;
at least one radiation source in optical communication with the plurality of flow channels; and
a multi-channel detector having a plurality of sensors in optical communication with the plurality of flow channels.

25. The system of claim 24 wherein at least a portion of each flow channel of the plurality of flow channels is optically imaged with a different sensor of the plurality of sensors.

26. The system of claim 24, further comprising a plurality of analytical process regions adapted to perform a plurality of substantially concurrent analytical processes, wherein each flow channel of the plurality of flow channels is in fluid communication with a different analytical process region of the plurality of analytical process regions.

27. The system of claim 26 wherein the plurality of analytical processes comprises chemical or biochemical separation processes.

28. The system of claim 27 wherein the chemical or biochemical separation processes comprise any of: chromatographic, electrophoretic, electrochromatographic, immunoaffinity, gel filtration, and density gradient separations.

29. The system of claim 24 wherein the at least one radiation source comprises a plurality of radiation sources, the system further comprising a radiation source selection element.

30. The system of claim 24 wherein the multi-channel detector comprises any of: a multi-channel photomultiplier, a multi-channel charge-coupled device, and a photodiode array.

31. The system of claim 24 wherein the multi-channel detector measures absorbance.

32. The system of claim 24 wherein the multi-channel detector measures fluorescence.

33. A multi-channel optical flow cell comprising:
a first end block defining a plurality of inlet ports and a plurality of outlet ports;
a flow layer defining a plurality of flow channels, with each flow channel of the plurality of flow channels being in fluid communication with a different inlet port of the plurality of inlet ports and being in fluid communication with a different outlet port of the plurality of outlet ports;
a second end block;
a first plurality of optical fibers;
a second plurality of optical fibers;
a first plurality of fluid conduits; and
a second plurality of fluid conduits;
wherein:
each flow channel of the plurality of flow channels is in optical communication with at least one optical fiber of the first plurality of optical fibers and with at least one optical fiber of the second plurality of optical fibers;
each fluid conduit of the first plurality of fluid conduits is affixed within a different inlet port of the plurality of inlet ports;
each fluid conduit of the second plurality of fluid conduits is affixed within a different outlet port of the plurality of outlet ports;
the flow layer is disposed between the first end block and the second end block.

34. The flow cell of claim 33, further comprising:
a first optical fiber termination block having a first surface, wherein each optical fiber of the first plurality of optical fibers is terminated substantially flush with the first surface; and
a second optical fiber termination block having a second surface, wherein each optical fiber of the second plurality of optical fibers is terminated substantially flush with the second surface;
wherein the flow layer is disposed between the first optical fiber termination block and the second optical fiber termination block, with the first optical fiber termination block and second optical fiber termination block being optically coupled through the flow layer.

35. The flow cell of claim 34 wherein:
the flow layer has an opposing third surface and fourth surface, with the first end block being disposed adjacent to the third surface and the second end block being disposed adjacent to the fourth source; and
the flow layer has an opposing fifth surface and sixth surface, with the first optical fiber termination block being disposed adjacent to the fifth surface and the second optical fiber termination block being disposed adjacent to the sixth surface.

36. The flow cell of claim 33 wherein the first end block and the flow layer are integrated into a unitary member.

37. The flow cell of claim 33 wherein any of the second end block and at least a portion of the flow layer comprises a substantially optically transmissive material.
